(19) United States
(12) Patent Application Publication
(10) Pub. No.: US 2002/0055901 A1
(43) Pub. Date: May 9, 2002

(54) Method and system for the electronic negotiation and execution of equity block trades for institutional investors

(76) Inventors: Nicholas B. Gianakouros, Cranford, NJ (US); David E. Shaw, New York, NY (US)

Correspondence Address: KENYON & KENYON, 1500 K STREET, N.W., SUITE 700, WASHINGTON, DC, 20005, US

(21) Appl. No.: 09/962,242

(22) Filed: Sep. 26, 2001

Related U.S. Application Data
(60) Provisional application No. 60/234,927, filed on Sep. 26, 2000.

(51) Int. Cl. G06F 17/60

(52) U.S. Cl. 705/37

(57) ABSTRACT

The present invention is directed to a system for the electronic negotiation and execution of block-size trades in financial instruments on behalf of institutional investors, and in particular, a system and method for the anonymous negotiation and execution of equity block trades for institutional investors based on trading information entered into the system by one or more broker participants who serve as intermediaries for any resulting transactions. In accordance with an embodiment of the present invention, a method for trading financial instruments includes receiving trade alerts, evaluating the trade alerts for possible trading opportunities, receiving approvals to proceed with one of the trading opportunities, and executing orders generated by the approvals.

### CROSS REFERENCE TO RELATED APPLICATIONS

This application claims the benefit under 35 U.S.C. § 119(e) of U.S. Provisional Application No. 60/234,927, filed Sep. 26, 2000.

### FIELD OF THE INVENTION

The present invention is directed to a system for the electronic negotiation and execution of block-size trades in financial instruments on behalf of institutional investors, and in particular, a system and method for the anonymous negotiation of equity block trades for institutional investors based on trading information entered into the system by one or more broker participants who serve as intermediaries for any resulting transactions.

### BACKGROUND OF THE INVENTION

Institutional investors who desire to buy or sell U.S. equity securities in block size (“block trades” are generally defined as individual trades of 10,000 shares or more) most commonly utilize the services of traditional agency brokers, a category which includes many of the largest Wall Street firms. These firms use their market expertise in an attempt to obtain favorable prices and minimize transaction costs while executing institutional orders as agent for a per-share commission.

Upon receipt of a block-size institutional order, traditional agency brokers attempt to find counterparties for the desired trade—for example, if the institutional order is to buy 100,000 shares of IBM, the broker will try to find one or more counterparties willing to sell 100,000 shares or more of IBM. The process of locating counterparties typically involves calling other institutional clients or brokers on the telephone to advertise the firm's trading interest and/or “working” the institutional order on the floor of organized stock exchanges—such as the New York Stock Exchange (“NYSE”) or the American Stock Exchange (“Amex”)—in the NASDAQ market for securities traded over-the-counter (“OTC”), and on crossing networks, electronic communication networks (“ECNs”), and other electronic trading systems, such as Reuters' Instinet® and ITG Inc.'s POSIT®.

Less commonly (and generally in a bid to reduce the amount of information regarding their trading interest flowing to any human agent, including sales/traders at traditional agency brokerage firms), institutional investors interested in trading equity blocks also utilize crossing networks, ECNs, and other electronic trading systems directly, using their own trading staff and in-house expertise to accumulate or liquidate large positions over the course of the trading day without the assistance of a traditional agency broker.

Regardless of the method or venue chosen for the execution of their block-size trades, the institutionalization of U.S. equity markets in recent decades has made it increasingly difficult for institutional investors (and their broker-dealer agents) to find the liquidity required to execute their ever-larger orders without creating excessive market impact (“market impact” or “slippage” is the price effect produced by trading). As the fraction of total equity shares held by institutional investors has increased, so too has the average size of institutional equity orders; in fact, it is no longer unusual for institutional investors to place individual orders in a single security to buy or sell one million shares or more.

Because the amount of liquidity normally provided by market-makers and other dealers (who are often willing to commit capital for smaller trades by buying and selling for their own account) in even the most actively traded securities is woefully inadequate to accommodate transactions of this size, institutional investors use various methods and participate in various trading venues in an effort to access the only truly efficient source of liquidity for such large orders—namely, other institutional investors with block-size trading interest on the opposite side of the market.

Unfortunately, the most common means of finding these “natural” counterparties—(1) giving orders to traditional agency brokers, who use various means to locate other institutions (or brokers representing other institutional clients) with substantial trading interest on the opposite side of the market, and (2) utilizing ECNs and other electronic trading systems directly in the hope of locating and trading with another institutional investor on the opposite side of the market—are cumbersome, inefficient, and (to various degrees) inherently subject to “information leakage” (e.g., the inadvertent disclosure of sensitive information regarding trading interest to opportunistic market participants).

In addition, because institutional investors interested in buying or selling a large block of shares often attempt to reduce market impact and the likelihood of adverse information leakage by hiding the true size of their orders even from their own brokers, large orders are often broken up and “worked” piecemeal in various trading venues over the course of one or more days, thereby resulting in potentially substantial “opportunity costs” for institutional investors, which would strongly prefer to be out of an unwanted position, or into a desired position, much more rapidly. According to Plexus Group, institutional investors incur, across institutional trading venues, an incredible $7 in such indirect transaction costs (i.e., slippage, opportunity cost, etc.) for every $1 spent on commissions.

While traditional agency brokers are normally very careful to keep confidential the identity of their institutional clients, the process of working a large institutional order virtually always requires the explicit or implicit disclosure by the broker of certain information to potential counterparties. This information, which typically includes the side and symbol of the institutional order and a representation of the order's size, sometimes finds its way into the hands of opportunistic traders who use it to “front run” the institutional order for their own profit—that is, trade for their own accounts on the same side of the same security on the expectation that the price effect produced by the subsequent execution of the larger institutional order will impact the price of the subject security in a manner that will result in quick profits for the opportunistic trader.

It should be noted that the adverse effect of the broker's disclosure of information concerning the institutional order's size to potential counterparties is often magnified by the tendency of brokers to market, or “shop”, the assumed total size of an institutional client's trading interest, and not merely the size of its received order. Based on its knowledge of an institutional investor's size, its previous experience handling the institution's orders, and nuances in the instructions received upon receipt of an order, traditional agency brokers often formulate highly accurate estimates of the true size of an institutional client's total trading interest and shop that trading interest to potential counterparties accordingly. While this practice is often damaging to the institutional investor whose order suffers even greater front-running and slippage costs, its ubiquity among traditional agency brokers is largely explained by the fact that it maximizes the likelihood that the broker will be able to execute the largest possible commissionable trade in the shortest amount of time.

Even incomplete information regarding an institutional order can be extremely valuable to opportunistic traders—merely knowing, for example, that an institutional investor is purchasing IBM—without knowing either the identity of the institution or exactly how many shares it wishes to purchase—is often enough to motivate anticipatory front-running by an opportunistic trader, who will immediately purchase IBM for his own account (pushing up the price of IBM in the process, to the institution's detriment) on the generally correct assumption that the institutional investor in question will purchase a substantial additional number of IBM shares, which trading will drive the price of IBM up even more, allowing the trader to liquidate his own position just a short time later at a significant profit. The more accurate or detailed the information available to opportunistic traders, the more effectively they are able to front-run institutional orders.

While reducing or eliminating the direct flow of sensitive trading information from the institutional investor to a human broker, direct utilization of crossing networks, ECNs, and other electronic trading systems also leaves institutional investors vulnerable to adverse information leakage, albeit through a different dynamic.

For example, an institution wishing to acquire a large position in MSFT might decide to purchase shares directly on Instinet, the largest and most liquid ECN, rather than utilizing the services of a traditional agency broker. Because ECNs are by their nature designed to display buy and sell orders submitted by participants to other ECN participants (and, in some cases, to the market at large, via the ECN's public quotation in a particular security), an institutional client would normally be extremely circumspect about submitting a large buy order in MSFT to Instinet, as other Instinet participants would be in a position to see the order and purchase MSFT ahead of the institution, thereby driving up the price of the stock.

In an effort to help alleviate the price impact associated with the display of large orders in the manner just described, many ECNs (including Instinet) allow participants to display only a portion of their order to other system participants, while hiding the remainder of the order's size (i.e., it's “reserve”) from display. This option makes it possible for an institution to enter an order to buy 50,000 shares of MSFT, for example, while displaying only, say, 3,000 shares of this order to other system participants.

In this example, while the institution's full order to buy 50,000 shares of MSFT is eligible for execution against one or more sell orders in MSFT submitted to Instinet, its much smaller displayed size of 3,000 shares is intended to reduce the likelihood of front-running by other market participants viewing the order. Because ECNs automatically replenish an order's displayed size following an execution for less than the order's full reserve size, however, it is often a simple matter for other ECN participants to surmise the existence of large reserves.

In the example cited above, entry of a 5,000-share sell order in MSFT priced to execute against the buy order already in the system would result in an immediate 5,000-share execution, with 45,000 total shares remaining on the buy order, which would continue to display a size of 3,000 shares. Opportunistic ECN participants observing that a 5,000-share execution failed to eliminate a nominal order to buy 3,000 shares would correctly surmise the existence of a sizable reserve attached to the order, and (to the institution's detriment) quickly trade for their own account ahead of the remainder of the institutional order.

While certain other electronic trading venues, including crossing systems such as POSIT, are less susceptible to the problem of order-display-driven information leakage endemic to ECNs because they do not display received orders on any screen or in any public quotation, as a practical matter this distinction merely serves to reduce information leakage (and therefore slippage costs) at the expense of increasing opportunity costs, as the lack of displayed trading interest (which effectively operates as a kind of “advertising” to attract liquidity from potential counterparties) serves to discourage the submission of orders to the system, thereby increasing the likelihood that orders which might have been successfully traded elsewhere (e.g., on the floor of the NYSE, on a regional stock exchange, or on Instinet) will languish unexecuted in the POSIT system.

Thus, while the various electronic trading venues commonly utilized by institutional investors to effect block-size equity trades may differ in the mix of their particular susceptibility to slippage and opportunity costs, none of these systems appear to confer a consistent, material transaction cost advantage over other systems or trading venues, for the execution of large equity block trades by institutional investors. Despite (and, in some cases, as a result of) the efforts of institutions and their agency brokers to be circumspect regarding the amount and type of information regarding their trading interest disclosed to other market participants in these various venues, the excessive transaction costs resulting from the inability to efficiently locate and trade in large size with other institutional investors—costs which are indirectly passed along to millions of mutual fund and pension fund shareholders—represent one of the most challenging problems facing the securities industry today.

It must be emphasized that while there are some institutional block trades for which the role of a traditional intermediary is vital—for example, trades for which a broker's capital commitment (i.e., its willingness to execute the institutional client's order as principal) or price negotiation skills (i.e., its ability to negotiate an execution price significantly above or below the current market price with potential counterparties) are required—the majority of institutional equity block trades handled by traditional participating brokers do not involve either capital commitment or meaningful price discovery. This is evidenced by statistics indicating that approximately 85% of block-size transactions in U.S. equities take place at or inside the national best bid and offer (“NBBO”) at the time of the trade, with the overwhelming majority of these trades involving no capital commitment whatsoever by the executing broker.

The simple fact, then, is that for the majority of institutional equity block trades, traditional agency brokers add value not by meaningfully negotiating the execution price (which is most commonly linked to the NBBO, and therefore passively determined) or by committing capital, but by using their knowledge of clients' trading activity and holdings together with their direct access to various exchange floors and other trading venues to locate trading counterparties. Similarly, electronic trading systems such as ECNs and crossing networks add value, not by committing capital (which effectively never happens) or by assisting in sophisticated price negotiation, but merely by providing a venue, however imperfect, that allows institutional investors (and other users) to find, and transact with, other market participants with trading interest on the opposite side of the market.

What is needed, therefore, is a system which will rationalize the process of trading equity blocks for institutional investors by allowing them to efficiently locate, and trade with, natural counterparties “directly” (e.g., in a manner that substantially reduces the likelihood of adverse information leakage to potential front-runners and other market participants) when broker liquidity and price negotiation are not required.

In order to maximize the value proposition for institutional investors, as well as the likelihood of institutional participation, such a system: (1) should be “passive” (e.g., it should not require institutional investors to submit orders to a new broker or system in order to be presented with opportunities to trade, nor should it require that they stop sending orders to trading venues they are already patronizing; instead, institutional investors should be able to participate in the system without any redirection of their order flow or other significant modification to their current order-placement behavior); (2) it should allow institutional investors to anonymously negotiate large block trades directly with other institutional investors without the intermediation of traditional agency brokers in the negotiating process; (3) it should reduce overall transaction costs by substantially diminishing the likelihood of adverse information leakage to potential front runners and other market participants without increasing opportunity costs; (4) it should minimize wasted effort by selectively facilitating trade negotiations only between institutional investors which have already evidenced their interest in trading the same security on opposite sides of the market; (5) it should be available to large institutional investors well-suited in terms of size and nature to provide liquidity to each other; and (6) it should preserve the functional intermediation of one or more existing agency brokers in the trade execution, commission, clearance, and settlement process, thereby preserving valuable trading, IPO, information, and soft-dollar relationships with one or more of such firms.

### SUMMARY OF THE INVENTION

The present invention is directed to a broker-to-broker alternative trading system designed to facilitate the efficient execution of equity block trades for institutional investors sponsored by agency brokers (“sponsoring brokers” or “participating brokers”). The system aggregates “trading alerts” submitted by participating brokers whenever they receive block-size working orders from institutional clients, uses these trading alerts to identify institutional counterparties who may be interested in trading for size “behind” their working orders, opens electronic, anonymous “negotiations” between such potential counterparties, and executes at the current market midpoint any trades successfully negotiated in this manner.

Trading alerts submitted by participating brokers merely reflect block-size agency orders received by such brokers and are not themselves orders. Participating brokers satisfy their received agency orders independently of the system, using their own usual procedures; entry of a trading alert into the system does not affect the broker's handling of its corresponding agency order. Each trading alert may include a security symbol for the received order, the side of the received order, a price limit for the received order (if applicable), a code identifying the originating institution, and a code identifying the submitting broker-dealer.

If the system identifies offsetting trading alerts (e.g., trading alerts on opposite sides of the same security for different institutional investors), it automatically opens a direct, electronic, anonymous, confidential, bilateral (or multilateral) negotiation channel between the corresponding institutional investors. Both the existence and the content of this electronic negotiation are completely invisible to all other institutional users and participating brokers on the system, including the brokers that submitted the subject trading alerts.

If a negotiation between the institutional investors is successful, the system immediately executes the agreed-upon trade as agent at the current market midpoint, with the applicable institutional participants' respective sponsoring brokers serving automatically (on their clients' behalf) as the system's counterparties for the transaction—i.e., for clearance and settlement purposes, every execution on the system is a trade between the system and a sponsoring broker, and never a trade between the system and an institutional investor. Institutional investors are immediately notified of their executions on the system; their respecting sponsoring brokers are not notified of these trades until after the close of trading on the day of the trade. The system charges participating brokers a fraction of a cent per share in commission for all trades executed on the system on behalf of their sponsored institutional clients; sponsoring brokers charge their institutional clients a per-share commission for all trades executed on the system on their behalf.

### BRIEF DESCRIPTION OF THE DRAWINGS

FIG. 1 illustrates a block diagram of an embodiment of the system in accordance with the present invention.

FIG. 2 is a system diagram of an embodiment of the present invention detailing individual software and other technology sub-components of the system.

FIG. 3 is a flowchart diagram illustrating the operation of the overall system process by which trading alerts are entered by participating brokers and block trades are negotiated by institutional clients in accordance with an embodiment of the present invention.

FIG. 4 is an illustration of the Institutional GUI in accordance with an embodiment of the present invention.

FIG. 5 is an illustration of the Broker GUI in accordance with an embodiment of the present invention.

### DETAILED DESCRIPTION

The present invention is described below in the context of trading equity securities. However, the invention is not so limited and can be easily adapted to allow the trading of other liquid assets, such as options, futures, bonds, derivatives, currencies, commodities, and the like. Accordingly, where the context permits, the terms “securities,” “stock,” and “shares,” when used herein, include other instruments that can be traded, such as, for example, options, futures, bonds, derivatives, currencies, and commodities. The terms “buy” and “sell” include, where appropriate, bid and offer, etc.

An embodiment of the present invention is directed to a computerized network (the “System”), operated as an alternative trading system (“ATS”) by a sponsoring broker-dealer (the “Firm”), that aggregates “trading alerts” entered into the System by various traditional agency brokers (“participating brokers” or “sponsoring brokers”) whenever they receive qualifying agency orders to buy or sell equity securities in block size (“agency orders”) from qualifying institutional clients, such as large pension funds and mutual funds (collectively, “institutions,” “institutional investors,” “institutional clients,” or “institutional users”).

In an embodiment of the System in accordance with the present invention, a trading alert entered into the System by a participating broker upon receipt of an agency order includes a security identifier (for example, the ticker symbol), the side of the trade (for example, “buy” or “sell”), the participating broker's name or broker-dealer identifier, and the originating institution's name (or some other institutional identifier), and reflects the agency order received by the participating broker. For example, upon receiving an agency order from Institution A to buy 100,000 shares of IBM, Participating broker X would (either automatically or manually) enter the following trading alert into the System—“IBM/BUY/BROKER X/INSTITUTION A”.

In other embodiments of the present invention, trading alerts may contain additional information, such as the price limit for the received agency order (if applicable) and/or the actual the number of shares in the agency order received by the participating broker from its institutional client.

Entry of this trading alert into the System would not per se affect the participating broker's handling of its received agency order—i.e., the participating broker would work to execute the agency order on behalf of its institutional client on the NYSE or elsewhere, pursuant to its standard practice—with one important caveat: the participating broker would (per the explicit, standing instructions of all institutional users) attempt to purchase or sell only the actual number of shares received in the order from the institutional client, and would not market or shop for a greater quantity of shares on the institutional client's behalf. The rationale for this modification in sponsoring broker behavior is that institutional investors will strongly prefer to execute large block trades through the System whenever possible, rather than suffer the higher transaction costs associated with the broker's traditional means of trading.

Because an institutional investor will almost always be keenly interested in getting its trading underway, however, and because the only way for it to participate in the System will be to send a block-size working order to a participating broker, an institutional user will not object to giving such an order to a participating broker for the first (generally small) piece of its total trading interest. If the institutional user finds counterparties and successfully trades on the System over the course of the day, it may not have to give the original broker any additional orders in the subject security. If there are no counterparties on the System in the subject security, or if the pace of transactions on the System is insufficient to meet the institutional user's needs, then it can give the broker additional orders to be executed in the traditional manner.

In any case, this protocol serves to maximize the likelihood that an institutional investor will be able to locate, and trade with, a natural counterparty as efficiently as possible through the System (when such a counterparty exists) without either suffering the opportunity cost of not trading some shares in the meantime through traditional means or alienating the sponsoring broker(s) it also relies on for a host of other services. Because any trade executed on the System by a sponsored institutional client is automatically a commissionable agency trade for the sponsoring broker, these brokers should have no objection to modifying their behavior to accommodate an institutional client's wishes in this manner. In accordance with an embodiment of the present invention, therefore, trading alerts entered into the System are not themselves orders to buy or sell securities, but merely reflect actual block-size agency orders received (and being worked) by participating brokers.

In an embodiment of the present invention, the System operates as an anonymous, non-display-based aggregator of trading alerts entered by participating brokers. In this embodiment, no participating broker may view (or otherwise access) any trading alert entered by another participating broker, but may view its own trading alerts—that is, trading alerts it has already entered to reflect agency orders it has previously received. Similarly, no institution may view (or otherwise access) any trading alerts entered on behalf of another institution, but may view (and, if desired, modify, as described in detail below) trading alerts entered on its behalf by one or more participating brokers. The System continually monitors trading alerts in the System in search of trading opportunities indicated by offsetting alerts (these are defined as trading alerts on opposite sides of the same security—for example, IBM/BUY/BROKER X/INSTITUTION A and IBM/SELL/BROKER Y/INSTITUTION B).

In general terms, whenever the System finds two offsetting alerts, it automatically opens a direct, electronic, anonymous, confidential, bilateral (or multilateral) negotiation channel between (or among) the corresponding institutional users. Because the original agency orders given to their respective sponsoring brokers typically represent only a small fraction of the total shares each institution actually desires to trade, the purpose of this negotiation is to allow the institutions to directly negotiate the terms of a potentially much larger block trade in the subject security in a manner that involves dramatically reduced information disclosure to other market participants, and therefore the potential for dramatically lower transaction costs, than would normally be associated with traditional agency trading methods.

Both the existence and the content of this electronic negotiation are completely invisible to all other institutional users and participating brokers on the System, including the sponsoring brokers which submitted the trading alerts in question. If the negotiating is unsuccessful, the negotiation channel closes without any other institutional user or any sponsoring broker ever learning of the negotiation's existence. If the negotiating institutional users agree on the terms for a block trade, the System immediately executes the agreed-upon trade (with the Firm acting as agent and executing broker) at the current market midpoint, with the applicable institutional participants' sponsoring brokers serving automatically (on their clients' behalf) as the Firm's counterparties for the transaction.

This last point should be emphasized—while institutional users utilize the System directly to negotiate block-size trades with other institutional users, it is their sponsoring brokers, and not the institutions themselves, who serve as the Firm's counterparties for any resulting transactions. This arrangement preserves existing broker/client relationships between institutional users and sponsoring brokers by ensuring the intermediation of sponsoring brokers in the trade execution, clearance, and settlement process. Acting as agents, participating brokers effectively purchase and sell shares on the System on their institutional clients' behalf, passing these trades along to their clients for a per-share commission, in a manner exactly analogous to having purchased or sold these shares on the floor of the NYSE.

Furthermore, whereas institutional users are immediately notified of any executions on the System, their sponsoring brokers are not notified of these trades (which, as described above, are legally and otherwise trades between the sponsoring brokers and the Firm) until after the close of trading on the day in question, thereby eliminating the flow of sensitive intraday post-trade information regarding institutional user activity on the System even to their own sponsoring brokers. Moreover, because the Firm acts as executing broker (and therefore as counterparty to sponsoring brokers) for all transactions on the System, sponsoring brokers never learn the identity of either the counterparty broker or the counterparty institutional client following a trade on the System.

Neither the manner by which institutional investor orders are transmitted to participating brokers nor the manner by which participating brokers submit trading alerts to the System are limited by the present invention. For example, in an embodiment of the present invention, orders might be transmitted to participating brokers by institutional investors in a traditional manner—e.g., via the telephone, or using an electronic communication facility already in use today—or, in the future, using other systems or technologies.

Upon receiving an institutional order, a participating broker will generally enter a corresponding trading alert into the System in one of two ways: (1) automatically, via an automated link between the System and the participating broker's internal agency blotter, or (2) manually, by having a member of the trading staff type the trading alert into its graphical user interface to the System (“Broker GUI”), if System integration with the participating broker's internal systems is either not desired or otherwise unfeasible. After a participating broker receives an agency order and enters a corresponding trading alert into the System, evidence of this trading alert will be visible only to the participating broker, via its Broker GUI, and to the “originating” institution, where it will appear on its separate graphical user interface to the System (“Institutional GUI”). (Of course, System operational and technical staff will also, as needed, have the ability to view trading alerts and monitor all other aspects of System operation.)

Within this embodiment of the present embodiment, institutions cannot enter trading alerts into the System directly; only trading alerts entered by participating brokers reflecting received agency orders are accepted by the System. This represents yet another System feature specifically designed to preserve participating broker intermediation (thereby strongly encouraging traditional agency broker participation in the System) in the block trading process.

The Institutional GUI (which serves as the interface for all activity on the System by institutional users) allows an institutional user to view and, if desired, customize (as described in this paragraph and in the paragraphs which follow) trading alerts that have been submitted on its behalf by sponsoring brokers, and will automatically alert the institutional users whenever a trading opportunity exists on the System. An institution may designate one of three “modes” (manual, automatic, and semi-automatic) for each of its trading alerts; a trading alert's mode determines the nature of the institutional user's participation on the System in the trading process for the symbol/side represented by that alert.

By putting a trading alert in “manual mode”, an institutional user indicates that it prefers to respond manually when the System notifies it through the Institutional GUI of an opportunity to trade on the symbol/side represented by that alert. Upon receiving such notification, an institutional user would manually type the quantity of shares it is willing to trade in the subject symbol/side, along with a price limit (if one is not already attached to the trading alert) representing the maximum (or minimum) price at which it is willing to buy (or sell) the specified number of shares. (As a reminder, transactions on the System take place at the midpoint of the NBBO at the time of the trade. Because the NBBO is constantly in flux, however, the actual execution price an institutional user will receive for a trade on the System is unknown prior to consummation of the transaction; the entry of a price limit therefore allows a user to designate a “worst-case” price in order to prevent an execution at a price at which an institutional user is unwilling to trade.)

A trading alert in manual mode cannot result in an execution without manual entry of information and subsequent confirmation by an institutional user. Trading alerts submitted by participating brokers automatically default to manual mode in the System. An institutional user may choose to attach a “standing” price limit to a trading alert in manual mode, in which case the user will not be notified of opportunities to trade in connection with that trading alert whenever the current market price would not permit an execution satisfying the alert's price limit (e.g., whenever the midpoint of the current NBBO is higher than the price limit in the case of a trading alert to buy, or lower than the price limit in the case of a trading alert to sell). This System feature is designed to reduce the number of unnecessary trading-opportunity notifications sent to institutional users by eliminating those notifications which would not produce trades at acceptable prices.

An institutional user may also elect to automate its negotiations for a particular trading alert by putting the alert into “automatic mode” and designating certain user-specified parameters that will govern any automatic executions which occur. These parameters include a price limit (the maximum or minimum price at which the institutional user is willing to transact, as explained above), a maximum trading size (the largest number of shares the user is willing to execute in an individual trade, which may be smaller than block size), a maximum trading frequency (the minimum elapsed time between trades), and a total trading size (the total number of shares a user is willing to execute in this symbol/side). Subject to these user-specified parameters, a trading alert in automatic mode is effectively on “auto-pilot” and may result in executions for the institutional user without any further manual intervention or confirmation.

As a general rule, a trading alert will only interact with offsetting trading alerts of the same mode—e.g., automatic-mode alerts will only trade against offsetting automatic-mode alerts, and manual-mode alerts will only generate trading-opportunity notifications against offsetting manual-mode. An exception to this rule is made for a third “mode” for trading alerts—“semi-automatic.” This mode combines features of manual-mode trading alerts and automatic-mode trading alerts by allowing institutional users to trade automatically (subject to their specified parameters) against automatic-mode alerts and manually (by responding in the manner described above to trading opportunity notifications) against manual-mode alerts.

In addition to being able to designate and change the mode (and applicable parameters) for any of its trading alerts at any time, an institutional user may also “activate” or “deactivate” any of its alerts at any time, depending on whether it is interested in trading additional shares. While all trading alerts submitted by sponsoring brokers initially default to being active, an institutional user might choose to deactivate one of its trading alerts if, for example, the institution has no desire to trade (or be notified of trading opportunities for) additional shares in the subject security. Deactivation of a trading alert by an institutional user blocks all trades, notifications, and negotiations which would otherwise have occurred on the basis of that alert. For all intents and purposes, a deactivated trading alert acts as if it isn't in the System at all.

The net effect of all of these available customizations is an impressive degree of control by institutional users over the trading process presented on the System. While institutional users are not required to alter their order-placement behavior or interact with the Institutional GUI (beyond launching the application) in any way in order to be presented with opportunities to trade—as a reminder, trading alerts submitted on an institutional user's behalf by sponsoring brokers automatically appear in the Institutional GUI, and (because their default settings are “active” and “manual mode”) automatically result in trading-opportunity notifications in the Institutional GUI when offsetting alerts are present in the System—the ability to change the mode of any trading alert, attach price limits and other trading parameters to it, and deactivate or reactivate it, all at any time and without any of these modifications being communicated to any sponsoring broker or any other institutional user, together with the System's extremely favorable information-disclosure and transaction-cost dynamics, combine to make embodiments of the present invention a uniquely powerful tool for transacting equity block trades.

Embodiments of the present invention are expected to be highly attractive vis-à-vis other electronic trading venues, and therefore very appealing to both institutional investors and sponsoring brokers. The following benefits for these participants, and the competitive advantages over other venues, are expected in embodiments of the present invention.

Institutional clients stand to benefit from the potentially substantial savings in the overall cost of trading for block trades negotiated and executed on the System. In general terms, the overall cost of trading can be divided into three components: commission, slippage (also called market impact), and opportunity cost:

Commission. The most obvious component of trading costs (along with other fixed costs, such as clearing), the commission is the charge per share that a broker receives in exchange for handling an order. The magnitude of a commission typically depends on a number of factors, including the size of the order involved and the provision of research and other services by the executing broker.

Slippage. Slippage, or market impact, is the price effect produced by trading. Stated simply, the price of a stock tends to move adversely when you trade it—buy orders normally push the price up and sell orders normally drive the price down. This price slippage can be considerable, especially if the order is for a significant fraction of the total number of shares normally traded in a given stock over the course of a day.

Opportunity Cost. A fund manager normally generates buy or sell orders after coming to the conclusion that his fund will have a higher intrinsic return (alpha), or a more favorable risk profile, after executing the contemplated set of trades than before executing the trades. The longer the fund stands in its pre-trade execution state, the longer the fund manager sacrifices the higher expected alpha or reduced risk of the post-trade portfolio. The stronger the fund manager's views about the desired fund positions, the larger the expected opportunity cost if the contemplated trades do not take place quickly.

Addressing the commission component of trading costs, the System may make it possible for participating brokers to charge a significantly lower per-share commission for trades negotiated on the System than for traditional agency trades because the System will greatly streamline the expensive, labor-intensive process of finding natural counterparties for, or otherwise working, institutional orders. In fact, to collect a commission for institutional client trades negotiated on the System, participating brokers must merely (1) enter trading alerts into the System to reflect received agency orders, and (2) confirm/clear/settle any trades executed on the System by sponsored institutional clients.

Turning now to the slippage component of trading costs, the System facilitates dramatically reduced slippage for institutional trades by (1) providing an efficient mechanism for finding and accessing the substantial liquidity provided by natural counterparties—e.g., other institutional investors, and (2) substantially reducing the amount of sensitive trading information explicitly or implicitly disclosed by institutional investors to other market participants (including their own brokers), thereby decreasing the likelihood of front-running, and reducing slippage cost more generally. The transaction cost savings associated with this reduced slippage are likely to be very substantial, and will accrue directly to millions of mutual fund and pension fund shareholders.

Finally, the System will allow institutional clients to significantly reduce opportunity cost by making it possible to trade very large blocks quickly and anonymously with natural counterparties. This will reduce or obviate the need to work large orders slowly over a period of many days (which approach is generally pursued in an attempt to reduce slippage and other transaction costs), thereby allowing institutional investors to more quickly liquidate large positions a portfolio manager finds unattractive, and/or acquire other, more attractive, positions.

Because the active participation of participating brokers is important to the System's operation and success, the System was designed to offer these brokers the following advantages in embodiments of the present invention.

By dramatically improving their existing service offering for the trading of large blocks, participating brokers stand to increase market share at the expense of non-participating brokers and established electronic venues for institutional trading, such as Instinet and POSIT.

By preserving broker intermediation for institutional block trades, participation in the System represents an effective means by which participating brokers can counter the competitive threat of any new or future ATSs and/or trading systems which offer similar institutional trading services while excluding an intermediary role for such brokers.

By streamlining and largely automating the process of locating institutional counterparties, and by off-loading the negotiation process for large block trades to institutional clients, the System will allow participating brokers to facilitate these transactions with less effort than is now required.

Participation in the System will require few or no modifications to existing institutional or participating broker systems, thereby limiting the up-front effort required for System use.

Embodiments of the present invention also offer advantages over other electronic trading venues. The past several years have witnessed a dramatic increase in the number and variety of ECNs and Alternative Trading Systems (“ATS”) offering trading services to institutional investors, most of which have failed to achieve “traction” (i.e., acceptance and regular participation) among institutional participants. Reasons for this failure include: (1) the lack of a “critical mass” of order flow—i.e., the limited trading interest and liquidity typically available on new systems quickly lead to institutional investor apathy, which further diminishes available liquidity, etc.; (2) failure to accommodate existing trading practices or entrenched relationships; (3) inadequate systemic protection against information leakage or other forms of “gaming” (i.e., manipulative or otherwise disingenuous behavior conducted in an attempt to glean proprietarily valuable information regarding institutional trading interest). Embodiments of the present invention were designed with these challenges specifically in mind and addresses these institutional concerns as follows:

The System is designed to be passive for institutional investors—i.e., because the System presents participating institutional investors with opportunities to trade large equity blocks based on information supplied, not by them, but by participating brokers, it does not require institutional clients to alter their current order-placement behavior. Because institutional clients are not required to send orders to the System (which, by definition, would require that those orders not be sent elsewhere), the System circumvents the “critical mass” problem, so long as a sufficient number of participating brokers prove willing to enter trading alerts into the System (the prospect of which is discussed in further detail below).

The System does not undermine the valuable existing relationships between institutions and participating brokers. Instead, by facilitating the ongoing intermediation of participating brokers in institutional block trades while still allowing institutional investors to dramatically reduce transaction costs when trading large equity blocks, the System leverages the strength of established industry practice.

Because trading alerts resident in the System reflect actual block-size orders that have already been received by participating brokers, the System is less susceptible to gaming than other trading venues which may allow participants to “probe” for institutional trading interest without committing significant trading interest to the market.

In an embodiment of the present invention, the System will be operated as an ATS by a broker-dealer which will serve as counterparty for all trades executed on the System by sponsoring brokers on behalf of their participating institutional clients. In this embodiment, the System would represent an effective competitive tool for participating brokers, who could market its advantages to institutional clients in a bid to gain institutional equity trading market share from non-participating traditional agency brokers as well as ECNs, crossing networks, and other electronic trading systems. The present invention is not, however, limited to such an embodiment.

In an alternative embodiment of the present invention, a similar System is operated by, or in close conjunction with, one or more ECNs, crossing networks, or other electronic trading systems. For example, a single ECN could enter into an exclusive strategic relationship with the System, under which arrangement it would automatically generate and submit trading alerts to the System to reflect ECN orders it receives (possibly above a certain threshold size) from large institutional clients. These clients would then use the System in the manner described above to negotiate and effect equity block transactions, with the ECN serving automatically as the Firm's counterparty for any trades successfully executed in this manner. In this alternative embodiment, an ECN could, by marketing the System's advantages to its institutional clients, make a competitive service offering in the institutional block trading arena (an arena for which traditional ECNs services are, by their nature, not particularly well suited), using the System to gain market share from the traditional agency brokers currently dominating this market segment.

In an embodiment of the present invention, trading alerts reflect block-size orders received from institutional investors. The present invention is not, however, limited to such an embodiment. In an alternative embodiment of the present invention, trading alerts may reflect trades (perhaps above a certain size threshold) already executed on behalf of institutional investors, or they may reflect some other indicator of trading interest in a particular symbol/side.

In an embodiment of the present invention, all transactions on the System are executed at the midpoint of the NBBO at the time of the trade. The present invention is not, however, limited to such an embodiment. In an alternative embodiment of the present invention, other pricing mechanisms may be used, whether passive—e.g., the bid or offer price, the opening or closing prices, VWAP-linked prices, etc.—or actively negotiated between institutional users through the System.

In an embodiment of the present invention, access to the System for trading purposes would be restricted to the largest institutional investors, and would exclude brokers, dealers, market-makers, retail investors, and other market participants. The present invention is not, however, limited to such an embodiment. In an alternative embodiment of the present invention, various categories of market participants interested in trading equity blocks would be allowed access to the System.

In an embodiment of the current invention, the System will run on several Internet-linked, high-performance workstations. All communication between the System and System participants, e.g., entry, modification, and display of trading alerts, all negotiation-related interactions, transmission of confirmed trade details to institutional users (and, following the close of trading, to sponsoring brokers), and so on, will take place through their respective GUIs over the public Internet using sophisticated encryption technology to ensure the security and confidentiality of transmitted information. The System will require no integration with institutional order management systems, and integration with participating broker systems (which would be required only to automate the process of entering trading alerts into the System) is strictly optional. Institutional users and participating brokers will be able to download their respective GUI Java applets over the Internet using a commercially available Internet browser, such as Microsoft Internet Explorer or Netscape Navigator. In an alternative embodiment of the present invention, dedicated telecommunications lines may be used in place of the public Internet.

In embodiments of the present invention, intended users of the System are typically, on the one hand, institutional investors (for example, a pension fund manager or a mutual fund manager as described above), and, on the other hand, the agency trading desks of broker-dealers. The manner by which institutional investor orders are transmitted to participating brokers is not limited by the present invention. For example, in an embodiment of the present invention, such orders might be transmitted in a traditional manner—e.g., via the telephone, or using an electronic communication facility already in use today—or, in the future, using other systems or technologies.

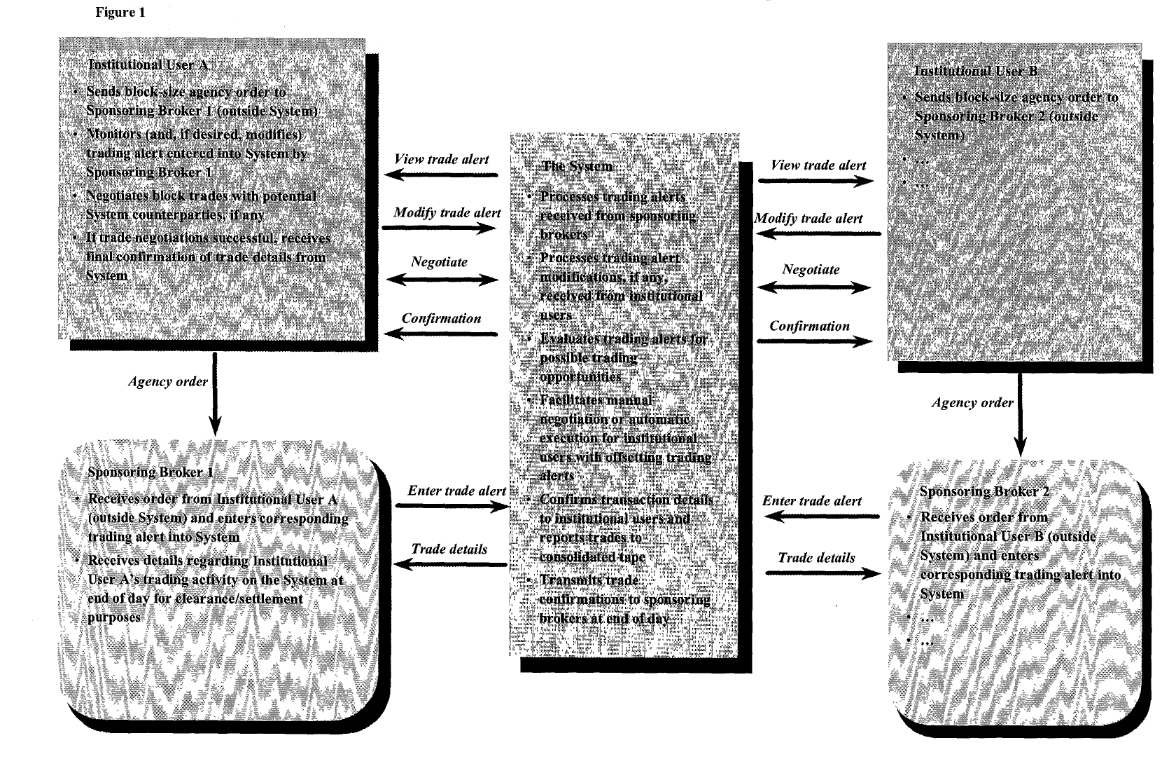

Referring now to the drawings, there is illustrated in FIG. 1 a block diagram of an embodiment of the System in accordance with the present invention. In an embodiment of the present invention, after receiving block-size agency orders from institutional clients (outside the System), sponsoring brokers enter corresponding trading alerts into the System via Web-based Broker GUIs. Institutional clients monitor (and, if desired, modify) trading alerts entered into the System by sponsoring brokers on their behalf via their own, separate, Web-based Institutional GUIs. The System constantly evaluates resident trading alerts for possible trading opportunities indicated by offsetting alerts. If offsetting alerts are found, the System facilitates manual negotiation or automatic execution for institutional users with offsetting trading alerts. The System immediately reports all resulting trades to institutional users and the consolidated tape. Following the close of trading, the System transmits details for all trades executed on behalf of institutional users to their respective sponsoring brokers for clearance and settlement purposes.

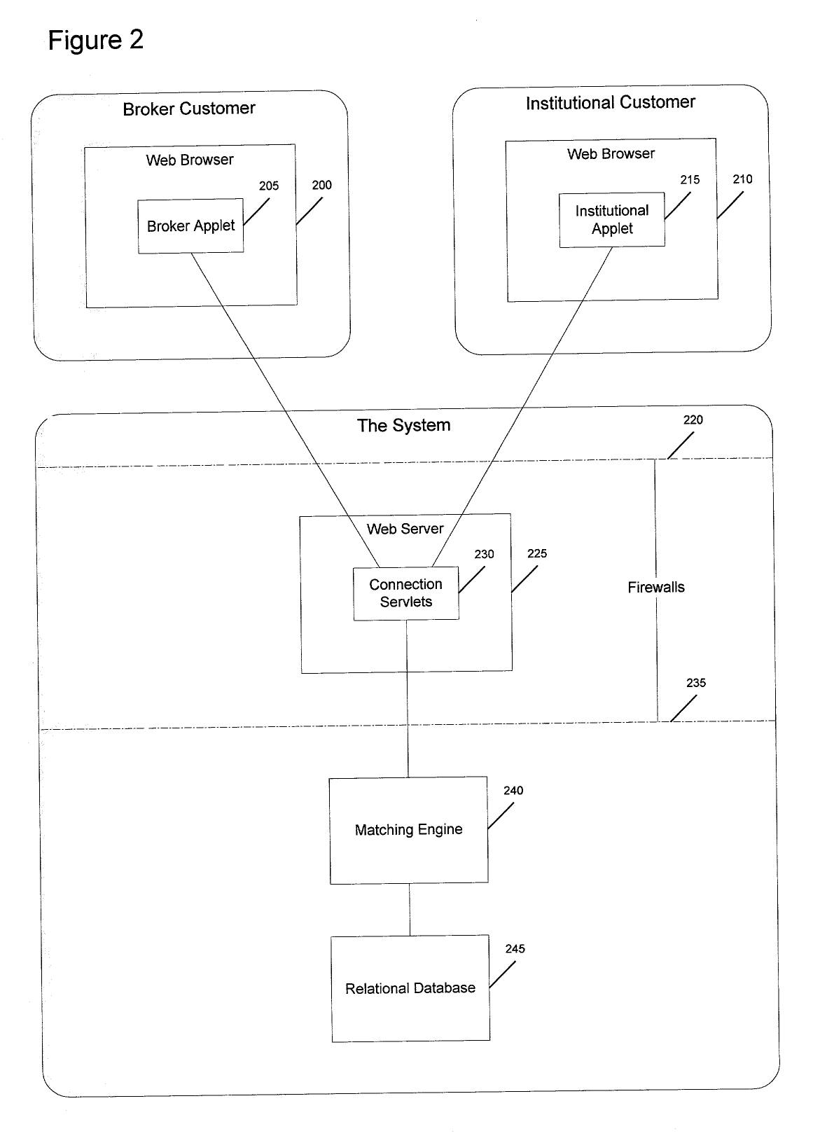

FIG. 2 is a system diagram of an embodiment of the present invention detailing individual software and other technology sub-components of the System. In accordance with an embodiment of the present invention, in order to download and launch the Broker GUI and Institutional GUI applications, agency brokers and institutional participants can use standard Web browsers (200 and 210, respectively) with applet support and simply enter the System's URL into their Web browser, which will direct it to the System Web server 225. All participants will connect to the System Web server 225. Firewall 220 guarantees that connections are allowed only from designated participant machines, and only to certain designated ports on the machine hosting the Web server.

The Web server 225 uploads the appropriate applet to the participant and spawns one Connection Servlet 230 per participant connection. The applet will obtain user credentials and authenticate the user with Matching Engine 240. Participating brokers will receive Broker Applet 205, whereas institutional users will receive Institutional Applet 215. Broker Applet 205 allows the user to accomplish tasks 305 (submission of trading alerts) and 343 (receipt of end of day summary information for trades successfully negotiated on the System by institutional participants). Institutional Applet 215 supports tasks 310 (modification of trading alerts submitted on behalf of the institution) and 325 (trade negotiation with institutional counterparties). Each Connection Servlet 230 acts as an intermediary between the Matching Engine 240 and the participant's applet. The purpose of the Connection Servlet is to further isolate the Matching Engine from the outside world, so that participants cannot subvert the Matching Engine or gain access to trading alert data for other participants. Firewall 235 ensures that only the Connection Servlet can connect to the Matching Engine.

The Matching Engine 240 is responsible for matching offsetting trading alerts submitted by Broker Applets, informing Institutional Applets of trading opportunities indicated by such matches, managing the negotiation process between Institutional Applets, and confirming executed trades to Broker Applets of agreed-upon trades. The Matching Engine will communicate with all participant applets using encryption. Even if the Connection Servlet is compromised, participant data will be secure, because all trading alert and negotiation-related data will be encrypted before it leaves the Matching Engine or a participant applet. The Matching Engine will use relational database 245 to store trade data and participant information. This may or may not be a replicated database (all data could be simultaneously stored on multiple databases for back-up purposes).

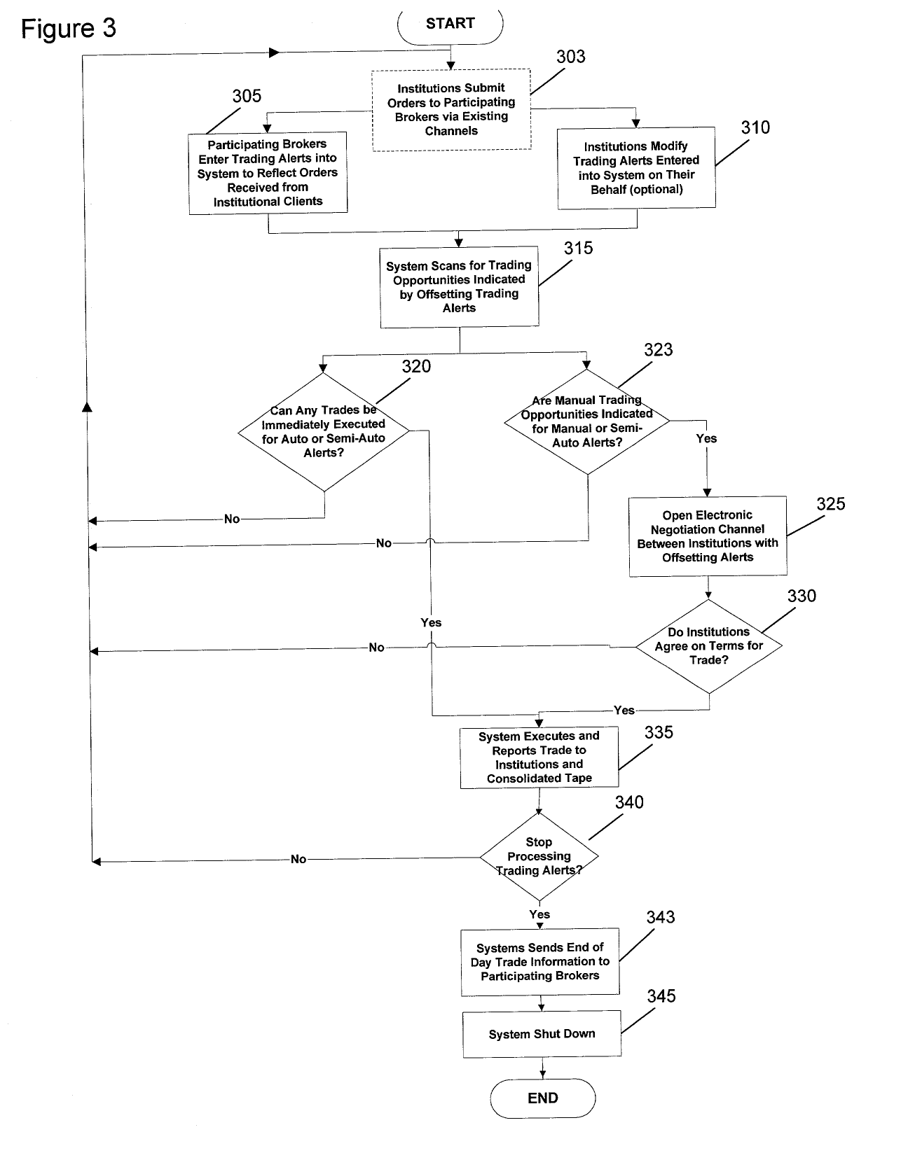

FIG. 3 is a flowchart diagram illustrating the operation of the overall System process by which institutional trading alerts are entered into the System by participating brokers and trade details are negotiated by institutional clients in accordance with an embodiment of the present invention. In FIG. 3, in block 303 institutional clients submit block-size buy and sell orders in a plurality of securities to their sponsoring brokers using traditional or other means. Although the action represented by block 303 takes place outside the System, this step is included in FIG. 3 in order to facilitate understanding of the overall System process in the context of existing institutional order-placement practice.

In block 305, an participating broker enters trading alerts into the System to reflect qualifying orders received from participating institutional clients. In block 310, an institutional user monitors and, if desired, modifies trading alerts entered into the System on its behalf by agency brokers, either before, concurrent with, or after block 305. In block 315, the System scans for trading opportunities indicated by offsetting trading alerts resident in the System. In block 320, a check is made to determine if any trades may be immediately and automatically executed for offsetting auto-mode and semi-auto-mode trading alerts already resident in the System. If so, flow continues with block 335, where the System executes and reports the trade to the institutions involved and to the consolidated tape.

Concurrent with block 320, a check is made in block 323 to determine if manual trading opportunities are indicated by offsetting manual-mode or semi-auto-mode trading alerts already resident in the System and, if so, flow continues with block 325, where the System opens an electronic negotiation channel between institutions with offsetting alerts. In block 330, a check is made to determine if a negotiation has ended with agreement on the terms for a trade. If agreement on trade terms has been achieved in block 330, flow continues with block 335, where the System executes and reports the trade to the institutions involved and to the consolidated tape.

In block 340, a check is made to determine if the System should stop accepting and/or otherwise processing trading alerts, and, if not, then flow continues with block 303, as described above. If, in block 340, it is determined that the System is to stop accepting and/or otherwise processing trading alerts, then in block 343 the System sends the end of day trade information to participating brokers regarding trades executed on the System by sponsored institutional clients, and, in block 345, the System shuts down.

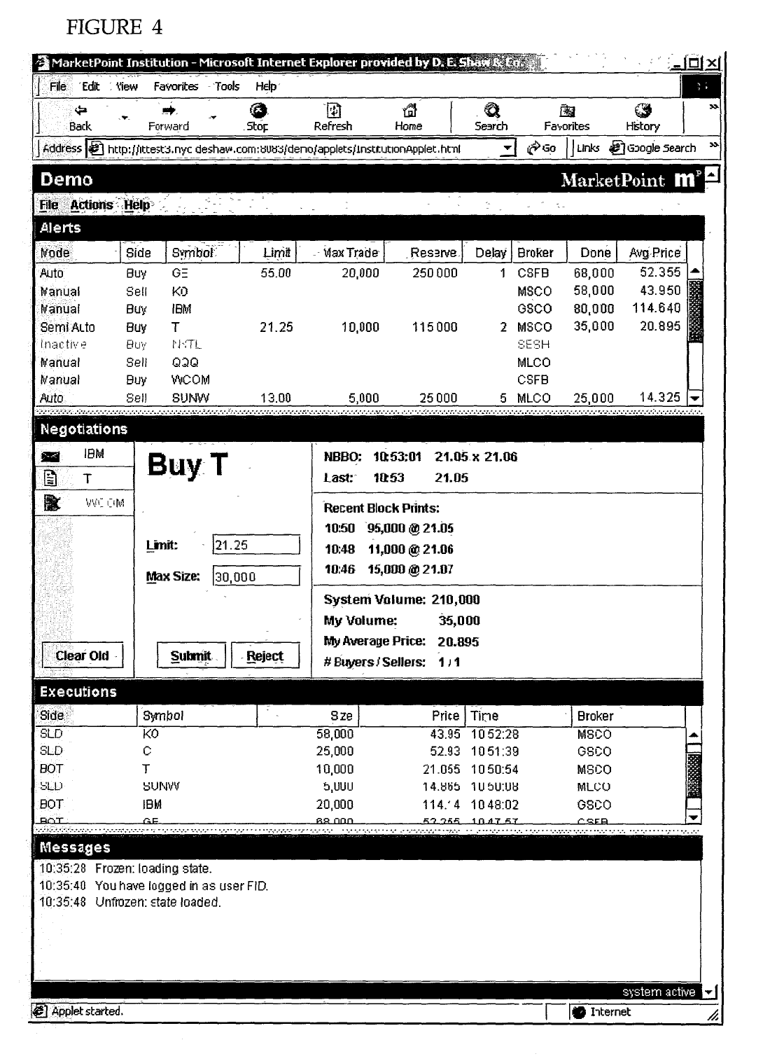

FIG. 4 is an illustration of the Institutional GUI in accordance with an embodiment of the present invention. The information contained in this Institutional GUI specifically reflects the activity of, or the activity on behalf of, a unique institutional user, and would be displayed only to that institutional user (the “represented institutional user”). This information could not be viewed by any other institutional investor or participating broker.

In FIG. 4, the “Alerts” window displays all of the trading alerts submitted by sponsoring brokers on behalf of the represented institutional user. Whenever a trading alert is submitted by a sponsoring broker for the represented institutional user, it automatically appears in this window, with the Side, Symbol, Broker, and Mode fields already populated. If the corresponding agency order spawning the trading alert which was given to a sponsoring broker included a limit price, the trading alert would also appear with the Limit field populated with this limit price. While the represented institutional user cannot modify the Side, Symbol, and Broker fields, it can customize each trading alert by modifying the Mode, Limit, Max Trade, Reserve, and Delay fields at any time. The Done and Avg Price fields indicate the number of shares executed, and the average execution price achieved, respectively, for each trading alert.

For manual-mode trading alerts, the represented institutional user is notified of the existence of pending negotiations (depicted as a closed envelope with a security symbol next to it) on the left side of the “Negotiations” window; clicking on a pending negotiation (which causes the envelope icon to open into a letter icon) causes a channel for this negotiation to appear in the main Negotiations window. This channel provides information regarding activity for the security in question, and invites the represented institutional user to type in and submit a trading size (in shares) and associated price limit for execution. The “Executions” window reports any trades executed on the System on the represented institutional user's behalf. The “Messages” window displays important System messages.

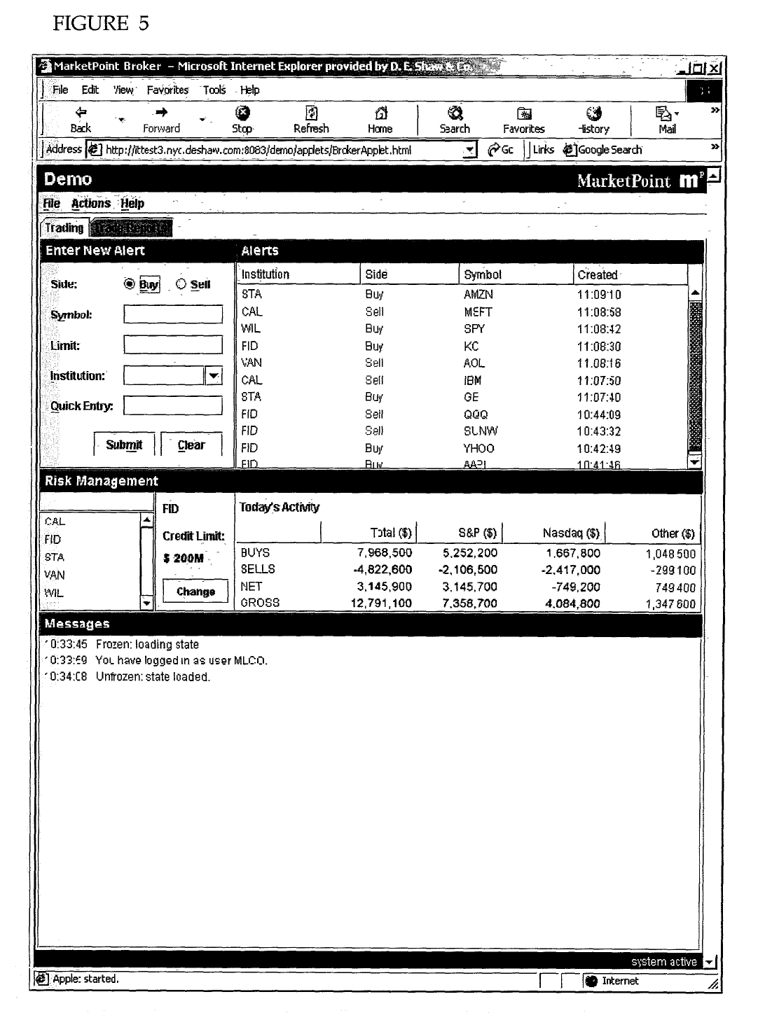

FIG. 5 is an illustration of the Broker GUI in accordance with an embodiment of the present invention. The information contained in this Broker GUI specifically reflects the activity of a unique sponsoring broker, and would be displayed only to that sponsoring broker (the “represented sponsoring broker”). This information could not be viewed by any other sponsoring broker or any institutional user.

In FIG. 5, the “Trading” tab of the Broker GUI is depicted. The “Enter New Alert” window allows the represented sponsoring broker to type in and submit trading alerts to the System to reflect block-size working orders received from institutional clients. The “Alerts” window lists trading alerts previously submitted by the represented sponsoring broker. The “Risk Management” window allows the represented sponsoring broker to designate credit limits for each of its sponsored institutional clients using the System (the credit limit represents the maximum aggregate dollar value of trades for which the represented sponsoring broker is willing to serve as counterparty on the System on behalf of each of its sponsored institutional clients), and to monitor the dynamically updating trading activity of each of its sponsored institutional clients on the System on a general level.

Thus, in FIG. 5, the represented sponsoring broker has designated a credit limit of $200 million for institutional client FID. The total aggregate dollar value of Institutional client FID's trading activity on the System on the date in question (and as of the time represented in the GUI) is $12,791,100. The breakdown of this trading activity by S&P 500 index securities, Nasdaq 100 index securities, and Other securities is depicted in this window. This Risk Management window therefore allows the represented sponsoring broker to designate and monitor its own risk exposure to each institutional client it has sponsored for participation on the System without learning of the specific symbols or quantities in which these trades occur. The “Messages” window displays important System messages. The “Trade Reports” tab of this GUI, which is indicated but not displayed in this diagram, allows the represented sponsoring broker to learn of the specific trades executed on the System on behalf of sponsored institutional clients. This tab is populated with this information by the System for clearance and settlement purposes only following the close of trading on the trade date in question.

The above embodiments are merely illustrative of numerous possible embodiments and therefore should not be construed so as to limit the scope of the invention. It should be understood that those skilled in the art would recognize that the principles of the invention can be used advantageously with alternative embodiments as well. Accordingly, all such implementations, which fall within the spirit and scope of the appended claims, will be embraced by the principles of the present invention.

What is claimed is:

1. A method for trading financial instruments comprising:
receiving a plurality of trading alerts;
evaluating said plurality of trading alerts for possible trading opportunities;
receiving approvals to proceed with at least one of said possible trading opportunities;
executing orders generated by said approvals; and
transmitting information regarding each of said executed orders.

2. The method of claim 1, wherein said plurality of trading alerts are received from at least one entity, said entity including one of:
a broker-dealer;
an order-routing service bureau;
a data aggregator; and
an institutional investor.

3. The method of claim 1, wherein each of said trading alerts includes a plurality of basic attributes, said basic attributes including:
a trading symbol for a financial instrument;
a buy/sell side; and
a client indicator identifying a client of said entity, if said client is different than said entity.

4. The method of claim 3, wherein said basic attributes further include:
an entity indicator identifying an entity from which the trading alert is received.

5. The method of claim 4, wherein said financial instrument includes one of:
an equity;
a bond;
a derivative;
a warrant; and
a future.

6. The method of claim 4, wherein said basic attributes associated with each of said trading alerts are received only from said entity from which the trading alert is received.

7. The method of claim 4, wherein each of said trading alerts includes at least one additional attribute, including:
a price limit;
a maximum quantity of said financial instrument to be traded;
a maximum frequency for trades in said financial instrument;
an instruction permitting automatic trading via standing instructions; and
a designation of said trading alert as being inactive.

8. The method of claim 7, wherein said price limit represents one of:
the maximum price in the case of a trading alert to buy at which said orders may be executed, and
the minimum price in the case of a trading alert to sell at which said orders may be executed.

9. The method of claim 7, wherein said additional attributes associated with each of said trading alerts, except for said price limit, are received only from said client for which the trading alert is received.

10. The method of claim 4, wherein each of said trading alerts received from said entity indicates at least one of:
receipt by said entity of an order from said client on said side of said trading symbol;
execution by said entity of at least one order on behalf of said client on said side of said trading symbol; and
receipt by said entity of a clear indication of trading interest by said client on said side of said trading symbol.

11. The method of claim 10, wherein each of said trading alerts received from said entity is prohibited from being displayed to any entity and to any client except for said client.

12. The method of claim 1, wherein said receiving a plurality of trading alerts includes at least one of:
receiving said trading alerts electronically, without manual intervention;
receiving said trading alerts electronically, with manual intervention; and
receiving said trading alerts via telephone.

13. The method of claim 7, wherein said evaluating said plurality of trading alerts for possible trading opportunities includes:
determining if at least two trading alerts are for the same instrument on opposite sides of the market; and
ensuring that the values of said additional attributes associated with each of said at least two trading alerts do not preclude a possible trade.

14. The method of claim 1, wherein said receiving approvals to proceed with at least one of said possible trading opportunities includes:
requesting approval to proceed with said at least one of said possible trading opportunities from each client for which one of said trading alerts associated with said at least one of said possible trading opportunities has been received; and
receiving said requested approval from each of said clients.

15. The method of claim 14, wherein said requesting approval and said receiving said requested approval occurs without notification to and without the knowledge of:
any entities from which said trading alerts have been received; and
any clients other than said clients.

16. The method of claim 14, wherein said requesting approval from said client includes:
notifying said client of said possible trading opportunity in connection with at least one of said trading alerts;
requesting a maximum number of shares to be executed;
requesting a price limit, if any; and
requesting final authorization to trade.

17. The method of claim 14, wherein said receiving said requested approval includes:
receiving a maximum number of shares to be executed;
receiving a price limit, if any, and
receiving final authorization to trade.

18. The method of claim 17, wherein said receiving said requested approval includes one of:
receiving approval via manual entry and confirmation by said client of said maximum number of shares to be executed, said price limit, if any, and said final authorization to trade; and
receiving automatic approval by said client via standing instructions regarding said maximum number of shares to be executed, said price limit, if any, and said final authorization to trade.

19. The method of claim 1, wherein said orders are generated upon said receipt of said approvals.

20. The method of claim 1, wherein said receiving a plurality of trading alerts, said evaluating said plurality of trading alerts for possible trading opportunities, said receiving approvals to proceed with at least one of said possible trading opportunities, said executing orders generated by said approvals, and said transmitting information regarding each of said executed orders are all performed by a broker-dealer.

21. The method of claim 1, wherein said executing of said orders includes one of:
executing said orders at passively determined prices; and
executing said orders at actively negotiated prices.

22. The method of claim 21, wherein said passively determined prices includes at least one of:
the midpoint of the national best and offer (“NBBO”) at the time of execution for a security in which said orders are executed;
another price linked to the NBBO at the time of execution for a security in which said orders are executed;
the market opening price for a security in which said orders are executed;
the market closing price for a security in which said orders are executed; and
a price linked to the volume-weighted-average-price for a security in which said orders are executed.

23. The method of claim 21, wherein said actively negotiated prices include an execution price agreed upon by the each client for which the orders are being executed.

24. The method of claim 2, wherein said orders are made by the entity from which a trading alert has been received, and not by the client of said entity for whom said trading alert has been received, when said entity is different than said client.

25. The method of claim 2, wherein said transmitting information regarding each of said executed orders includes:
transmitting execution details for each of said executed orders to at least one client for which an order was executed; and
transmitting execution details for each of said executed orders to the entity from which each order's associated trade alert was received.

26. The method of claim 25, wherein said transmitting execution details to at least one client includes:
transmitting a trade confirmation for each of said executed orders immediately upon execution of said orders to the client for which said order was executed;
transmitting a trade confirmation for each of said executed orders at a later time to the entity from which each order's associated trade alert was received.

27. The method of claim 26, wherein said later time includes at least one of:
a fixed delay following said execution of said order; and
a fixed time following the close of trading on the day of said execution.

28. A computer system for trading financial instruments comprising:
a storage device configured to store trading alerts;
a communications device; and
a server configured to receive via said communications device a plurality of said trading alerts, said trading alerts being stored in said storage device, said server further configured to evaluate said plurality of trading alerts for possible trading opportunities; said server further configured to receive via said communications device approvals to proceed with at least one of said possible trading opportunities; said server further configured to execute orders generated by said approvals; and said server further configured to transmit information regarding each of said executed orders.

29. The system of claim 28, wherein said plurality of trading alerts are received from at least one entity, said entity including one of:
a broker-dealer;
an order-routing service bureau;
a data aggregator; and
an institutional investor.

30. The system of claim 28, wherein each of said trading alerts includes a plurality of basic attributes, said basic attributes including:
a trading symbol for a financial instrument;
a buy/sell side; and
a client indicator identifying a client of said entity, if said client is different than said entity.

31. The system of claim 30, wherein said basic attributes further include:
an entity indicator identifying an entity from which the trading alert is received.

32. The system of claim 31, wherein said financial instrument includes one of:
an equity;
a bond;
a derivative;
a warrant; and
a future.

33. The system of claim 31, wherein said basic attributes associated with each of said trading alerts are received only from said entity from which the trading alert is received.

34. The system of claim 31, wherein each of said trading alerts includes at least one additional attribute, including:
a price limit;
a maximum quantity of said financial instrument to be traded;
a maximum frequency for trades in said financial instrument;
an instruction permitting automatic trading via standing instructions; and
a designation of said trading alert as being inactive.

35. The system of claim 34, wherein said price limit represents one of:
the maximum price in the case of a trading alert to buy at which said orders may be executed, and
the minimum price in the case of a trading alert to sell at which said orders may be executed.

36. The system of claim 34, wherein said additional attributes associated with each of said trading alerts, except for said price limit, are received only from said client for which the trading alert is received.

37. The system of claim 31, wherein each of said trading alerts received from said entity indicates at least one of:
receipt by said entity of an order from said client on said side of said trading symbol;
execution by said entity of at least one order on behalf of said client on said side of said trading symbol; and
receipt by said entity of a clear indication of trading interest by said client on said side of said trading symbol.

38. The system of claim 37, wherein each of said trading alerts received from said entity is prohibited from being displayed to any entity and to any client except for said client.

39. The system of claim 28, wherein said receiving a plurality of trading alerts includes at least one of:
receiving said trading alerts electronically, without manual intervention;
receiving said trading alerts electronically, with manual intervention; and
receiving said trading alerts via telephone.

40. The system of claim 34, wherein said evaluating said plurality of trading alerts for possible trading opportunities includes:
determining if at least two trading alerts are for the same instrument on opposite sides of the market; and
ensuring that the values of said additional attributes associated with each of said at least two trading alerts do not preclude a possible trade.

41. The system of claim 28, wherein said receiving approvals to proceed with at least one of said possible trading opportunities includes:
requesting approval to proceed with said at least one of said possible trading opportunities from each client for which one of said trading alerts associated with said at least one of said possible trading opportunities has been received; and
receiving said requested approval from each of said clients.

42. The system of claim 41, wherein said requesting approval and said receiving said requested approval occurs without notification to and without the knowledge of:
any entities from which said trading alerts have been received; and
any clients other than said clients.

43. The system of claim 41, wherein said requesting approval from said client includes:
notifying said client of said possible trading opportunity in connection with at least one of said trading alerts;
requesting a maximum number of shares to be executed;
requesting a price limit, if any; and
requesting final authorization to trade.

44. The system of claim 41, wherein said receiving said requested approval includes:
receiving a maximum number of shares to be executed;
receiving a price limit, if any, and
receiving final authorization to trade.

45. The system of claim 44, wherein said receiving said requested approval includes one of:
receiving approval via manual entry and confirmation by said client of said maximum number of shares to be executed, said price limit, if any, and said final authorization to trade; and
receiving automatic approval by said client via standing instructions regarding said maximum number of shares to be executed, said price limit, if any, and said final authorization to trade.

46. The system of claim 28, wherein said orders are generated upon said receipt of said approvals.

47. The system of claim 28, wherein said receiving a plurality of trading alerts, said evaluating said plurality of trading alerts for possible trading opportunities, said receiving approvals to proceed with at least one of said possible trading opportunities, said executing orders generated by said approvals, and said transmitting information regarding each of said executed orders are all performed by a broker-dealer.

48. The system of claim 28, wherein said executing of said orders includes one of:
executing said orders at passively determined prices; and
executing said orders at actively negotiated prices.

49. The system of claim 48, wherein said passively determined prices includes at least one of:
the midpoint of the national best and offer (“NBBO”) at the time of execution for a security in which said orders are executed;
another price linked to the NBBO at the time of execution for a security in which said orders are executed;
the market opening price for a security in which said orders are executed;
the market closing price for a security in which said orders are executed; and
a price linked to the volume-weighted-average-price for a security in which said orders are executed.

50. The system of claim 48, wherein said actively negotiated prices include an execution price agreed upon by the each client for which the orders are being executed.

51. The system of claim 29, wherein said orders are made by the entity from which a trading alert has been received, and not by the client of said entity for whom said trading alert has been received, when said entity is different than said client.

52. The system of claim 29, wherein said transmitting information regarding each of said executed orders includes:
transmitting execution details for each of said executed orders to at least one client for which an order was executed; and
transmitting execution details for each of said executed orders to the entity from which each order's associated trade alert was received.

53. The system of claim 52, wherein said transmitting execution details to at least one client includes:
transmitting a trade confirmation for each of said executed orders immediately upon execution of said orders to the client for which said order was executed;
transmitting a trade confirmation for each of said executed orders at a later time to the entity from which each order's associated trade alert was received.

54. The system of claim 53, wherein said later time includes at least one of:
a fixed delay following said execution of said order; and
a fixed time following the close of trading on the day of said execution.

55. A method for trading financial instruments comprising:
means for receiving a plurality of trading alerts;
means for evaluating said plurality of trading alerts for possible trading opportunities;
means for receiving approvals to proceed with at least one of said possible trading opportunities;
means for executing orders generated by said approvals; and
means for transmitting information regarding each of said executed orders.
